(19) United States
(12) Patent Application Publication
(10) Pub. No.: US 2024/0062318 A1
(43) Pub. Date: Feb. 22, 2024

(54) SYSTEM FOR ENABLING DIRECT MONETIZATION OF CONTENT THROUGH NON-FUNGIBLE TOKENS AND METHOD THEREOF

(71) Applicant: Wildr Inc., San Francisco, CA (US)

(72) Inventors: Amit Roy Sharma, Sydney (AU); Melissa Ravi, San Francisco, CA (US); Vidit Drolia, San Francisco, CA (US)

(21) Appl. No.: 18/453,457

(22) Filed: Aug. 22, 2023

Related U.S. Application Data
(60) Provisional application No. 63/400,042, filed on Aug. 22, 2022.

(51) Int. Cl. G06Q 50/00; G06Q 20/06

(52) U.S. Cl. CPC G06Q 50/01; G06Q 20/065; G06Q 2220/12; G06Q 2220/18

(57) ABSTRACT

The present invention discloses a system (100) for direct content monetization through a Non-Fungible Token (NFT) on a social networking platform (101). Users are provided with a Content Creation Module (102) that empowers them to generate diverse digital content. A Conversion Module (103) transforms user-generated content into valuable NFTs. A Display Module (104) seamlessly integrates NFTs into the platform's interface, enhancing content visibility. An Economic Transaction Module (105) enables various economic transactions involving NFTs. A Payment Processing Module (106) offers flexible payment options, including cryptocurrencies and fiat currency. The system harnesses blockchain technology (107) to ensure transparent and secure recording of NFT ownership and transactions. Together, these components redefine content monetization, bridging the gap between creators and their audiences, and creating a unified platform for content creators to realize the full potential of their creations.

### CROSS-REFERENCE TO RELATED APPLICATIONS

This application claims priority from U.S. provisional application Ser. No. 63/400,042 filed on 22 Aug. 2022 entitled “METHODS AND SYSTEMS OF ONLINE SOCIAL NETWORKING”, the entirety of which is herein incorporated by reference.

### DESCRIPTION OF THE INVENTION

### Technical Field of the Invention

The present invention relates to a field of digital content monetization within an online social networking application. Specifically, the invention pertains to a system for enabling direct monetization of user-generated content within an online social networking application through the conversion of individual posts into Non-Fungible Tokens (NFTs) enabling user to participate in various economic transactions such as selling, renting, or licensing their content directly within the social networking environment and the related method.

### BACKGROUND OF THE INVENTION

In the current landscape of digital content creation and online social networking, there exists a variety of methods for content sharing and engagement. However, the existing approaches often fall short in adequately addressing the needs and aspirations of content creators.

Existing online social networking platforms offer limited avenues for content creators to monetize their work. While some platforms provide advertisement-based revenue sharing, the model often leads to uneven earnings and is primarily accessible to established creators.

Further, the conventional methods of content monetization, such as crowdfunding, subscriptions, and merchandise sales, often require content creators to manage multiple platforms and engage in intricate payment processing procedures.

The available systems lack support for crypto currencies and hurdles in converting digital earnings into traditional fiat currencies.

Content creators often lack direct engagement with their audience during economic transactions, leading to reduced user interaction and limited opportunities for building a loyal fan base.

The Patent Application No. US2020320644A1 titled “Systems and Methods for autonomous branding using a platform that contains a plurality of features and functions that enable any user to have access to a complete digital presence and monetization opportunities” pertains to an invention encompassing a system and method for enhancing and monetizing one's social media presence. Within this context, the present innovation introduces an artificial technique for the management of social media interactions. Certain embodiments of this system and method are intended for user-centric software implementation, catering to entities like small businesses, aiming to streamline and execute their online digital strategies. Leveraging a digital web-based platform, the technology is employed to establish and amplify a brand's online visibility. In specific instances, these systems and methods offer streamlined publication, syndication, and monetization of content from a singular interface, while also facilitating the monitoring and engagement with information pertinent to said content.

The Patent Application No. US2016004977A1 titled “Content Monetization System” pertains to an innovation focused on a system and method designed to monetize content through the implementation of machine learning algorithms for content redaction. The inventive concept seeks to elevate the conversion rate of website visitors into paying customers. Extracted textual components of the content undergo tokenization and subsequent scoring, normalized within the range of [0, 1], to quantify their significance. A comprehensive approach is employed, utilizing intra-token, inter-token, extra-token, and tagged token features to characterize individual tokens. Sentences, paragraphs, sections, and even chapters are attributed scores based on token scores, employing diverse methodologies. Subsequently, the content is selectively redacted based on these calculated scores. Customers have the option to preview redacted content at no cost, with the opportunity to make a purchase for unrestricted access to the complete, non-redacted version. The present invention holds practicality in the publication and monetization of digital content, particularly in contexts such as e-books.

In conclusion, despite the advancements in technology and the prevalence of social media platforms, certain gaps persist within the digital content monetization landscape. Thus, there is a need for an innovative solution that can bridge the deficiencies enabling creators to easily monetize their content through NFTs, offering a range of payment options, engagement opportunities, and a unified platform. The transformation of the digital content landscape empowers creators to fully realize the value of their creative endeavors.

### SUMMARY OF THE INVENTION

The present invention overcomes the drawbacks of the prior art by disclosing an innovative system of direct content monetization through NFT and related method. This inventive system revolutionizes the way by which the content creators monetize their work within an online social networking application. By seamlessly integrating content creation, NFT generation, and economic transactions, the invention enables creators to effortlessly convert their posts into NFTs, thereby expanding their monetization opportunities. The system offers diverse payment options, encompassing both cryptocurrency and traditional fiat currency. Through this comprehensive approach, the invention empowers content creators to maximize the value of their creative efforts and bridges the gap between content generation and financial gain in the digital age.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a block diagram disclosing a system for enabling direct monetization of content through Non-Fungible Tokens.

FIG. 2 illustrates a flow diagram disclosing the method involved in direct monetization of content through Non-Fungible Tokens.

### DETAILED DESCRIPTION OF THE INVENTION

Reference will now be made in detail to the description of the present subject matter, one or more examples of which are shown in figures. Each example is provided to explain the subject matter. Various changes and modifications obvious to one skilled in the art to which the invention pertains, are deemed to be within the spirit, scope and contemplation of the invention.

The terminology used in the description presented herein is not intended to be interpreted in any limited or restrictive way, simply because it is being utilized in conjunction with detailed description of certain specific embodiments of the invention.

The present invention introduces a unique system of direct content monetization through NFT and the related method, redefining content monetization within an online social networking application. By seamlessly integrating content creation, NFT generation, and economic transactions, the invention simplifies the conversion of user-generated posts into NFTs, expanding opportunities for revenue. It offers diverse payment options, encompassing cryptocurrencies and conventional fiat currency.

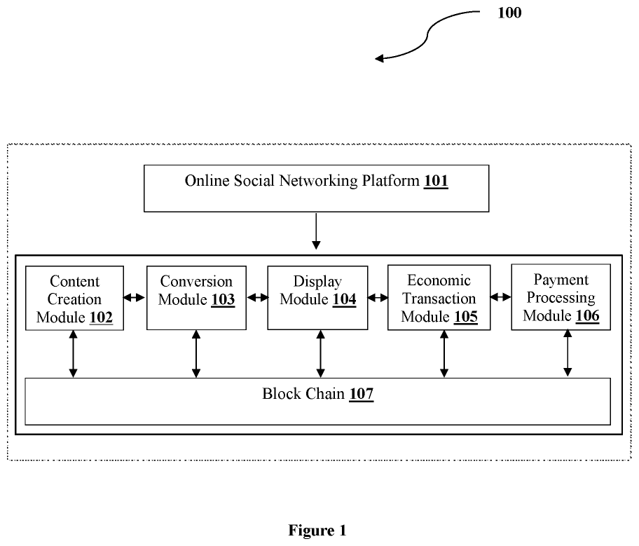

FIG. 1 illustrates a block diagram disclosing a system (100) for enabling direct monetization of content through Non-Fungible Tokens on social networking platform (101). The system (100) intricately weaves together a series of interconnected modules, each playing a pivotal role in the content monetization process. The Content Creation Module (102) empowers users to generate diverse digital content, which then seamlessly flows to the Conversion Module (103). Here, content's attributes are evaluated, and upon meeting specific criteria, it is transformed into valuable NFT. The Display Module (104) strategically integrates the NFT on the social networking platform (101), facilitating engagement and discovery for both creators and consumers. The Economic Transaction Module (105) extends the functionality, enabling secure and transparent economic exchanges involving the NFT. Financial aspects are handled by the Payment Processing Module (106), offering diverse payment options for seamless transactions. To ensure transparency and security, Blockchain Technology (107) underpins the entire ecosystem, safeguarding NFT ownership and transaction records.

In one embodiment of the disclosed system (100) as shown in FIG. 1, the content creation module (102) is provided to empower users to generate digital content within a social networking platform (101). The content creation module (102) offers a user-friendly interface that enables content creators to compose and design various types of multimedia posts, including images, videos, audio, and textual content. This embodiment emphasizes the seamless integration of content creation, fostering an environment where users unleash their creativity and contribute engaging material to the platform. The content creation module (102) serves as the starting point for content monetization by allowing the users to produce unique and compelling content that can subsequently be converted into NFTs.

In another embodiment, the conversion module (103) within the system (100) plays a pivotal role in transforming a user-generated content into a valuable Non-Fungible Token (NFT). Once a content meets predefined criteria, the conversion module (103) generates NFTs with accompanying metadata.

In yet another embodiment, the display module (104) enriches the user experience by seamlessly incorporating the generated NFTs into the social networking platform (101). By integrating NFTs into the user interface, the Display Module (104) allows content creators to view their NFTs and potential buyers to discover and engage with them.

In a further embodiment, the economic transaction module (105) acts as a conduit for various economic transactions involving NFTs. An user is engaged in purchasing, renting, licensing, and other forms of transactions directly through the social networking platform (101). The economic transaction module (105) ensures secure and efficient processes for exchanging NFTs and associated rights, enhancing the overall monetization experience for both content creators and consumers.

Lastly, in an additional embodiment, the payment processing module (106) contributes to the financial fluidity of the system (100) by offering multiple payment options, including crypto currency and traditional fiat currency. The payment processing module (106) processes payments securely, and ensures that transactions are completed seamlessly. This embodiment enables a user to participate in economic transactions without encountering payment barriers.

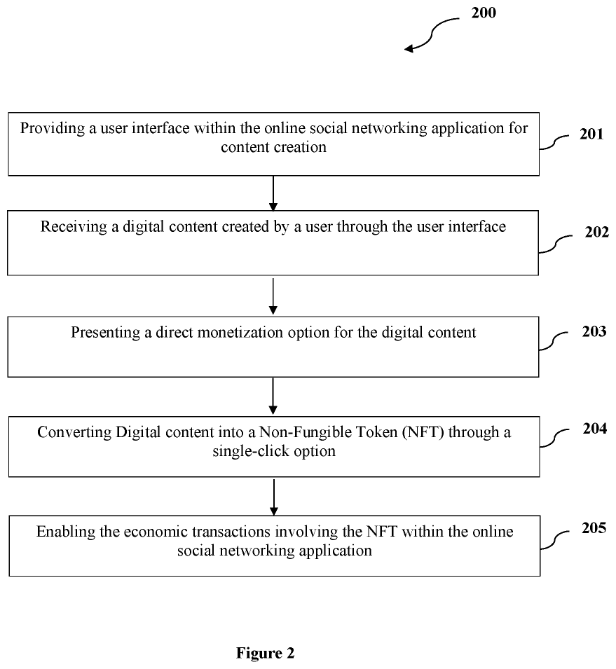

FIG. 2 illustrates a flow diagram disclosing a method involved in a direct monetization of content through a Non-Fungible Token (200). The method (200) unfolds through a series of steps, commencing with a step (201), which involves a content creation module within an online social networking application for the creation of content. Progressing to step (202), a digital content is created by a user. Moving forward, step (203) focuses on a direct monetization option for the digital content. This leads to a smooth transition into step (204), where digital contents are converted into a Non-Fungible Token (NFT) through a single-click option. Finally at step (205), economic transactions involving the NFT within the online social networking application is enabled.

There are several advantages of the present invention including seamless combined content creation, monetization, and engagement within a single online social networking environment.

Another advantage of the invention is that it enables content creators to directly monetize their work through the conversion of individual posts into Non-Fungible Tokens (NFTs). This streamlined process eliminates the complexities associated with traditional monetization models and provides creators with a convenient and efficient means of earning from their content.

Yet another advantage is the offering of various economic transactions, such as selling, renting, and licensing NFTs, the invention expands the revenue-generating potential for creators, catering to different preferences and audience demands.

Moreover, the invention provides the inclusion of cryptocurrency payment options alongside traditional fiat currency methods, offering creators a broader range of payment choices and enabling them to leverage the advantages of blockchain technology.

Further, through the integration of NFTs, content creators can foster direct engagement with their audience during transactions, forging stronger connections and building a more dedicated fan base.

Furthermore, the invention's seamless payment processing and diverse currency options overcome geographical barriers, making it easier for creators around the world to monetize their content and connect with a global audience.

In conclusion, the system of direct content monetization through NFT is a groundbreaking invention that addresses the limitations of current content monetization methods within online social networking platforms. By enabling creators to easily monetize their content through NFTs and offering a range of payment options, engagement opportunities, and a unified platform, this invention transforms the digital content landscape and empowers creators to fully realize the value of their creative endeavors.

TABLE 1
Reference numbers:

| Components | Reference Numbers |
|---|---|
| System | 100 |
| Online Social Networking Platform | 101 |
| Content Creation Module | 102 |
| Conversion Module | 103 |
| Display Module | 104 |
| Economic Transaction Module | 105 |
| Payment Processing Module | 106 |
| Blockchain Technology | 107 |

We claim:

1. A system for enabling a direct monetization of a content within an online social networking application, the system (100) comprises:
a. a content creation module (102) configured to create a digital content by a user;
b. a conversion module (103) configured to generate a Non-Fungible Token (NFT) associated with the digital content;
c. a display module (104) configured to display the generated NFT within the online social networking application;
d. an economic transaction module (105) configured to facilitate one or more economic transactions involving the NFT within the online social networking application including purchasing, renting; and
e. a payment processing module (106) configured to enable one or more payments for the economic transactions through one or more form of a flat currency and a cryptocurrency.

2. The system (100) as claimed in claim 1, wherein the conversion module (103) presents a direct monetization option for the digital content, enabling the user to convert the digital content into the NFT through a single-click option.

3. The system (100) as claimed in claim 1, wherein the NFT includes references to the plurality of digital contents comprising photos, video and audio files.

4. A method for enabling a direct monetization of a content within an online social networking application, the method (200) comprising steps of:
a. providing a content creation module within the online social networking application for the generation of a content (201);
b. receiving a digital content created by a user through the user interface (202);
c. presenting a direct monetization option for the digital content, wherein the direct monetization option enables the user to convert the digital content into a Non-Fungible Token (NFT) through a single-click option (203);
d. generating the NFT associated with the converted digital content (204); and
e. enabling the economic transactions involving the NFT within the online social networking application (205).

5. The method (200) as claimed in claim 4, wherein the NFT includes plurality of references to digital contents and associated metadata.

6. The method (200) as claimed in claim 4, wherein the economic transactions include one or more options for purchasing, renting, or other transactions.

7. The method (200) as claimed in claim 4, wherein the payment methods for the economic transactions is at least one of a crypto currency and a fiat currency.
